(19) United States
(12) Patent Application Publication
(10) Pub. No.: US 2020/0001445 A1
(43) Pub. Date: Jan. 2, 2020

(54) CHISEL

(71) Applicants: BRENT GORDON MCARTHUR, SHENZHEN (CN); WILLIAM KEVIN BREWSTER, SHENZHEN (CN); XIAOYUAN MA, SHENZHEN (CN)

(72) Inventors: BRENT GORDON MCARTHUR, SHENZHEN (CN); WILLIAM KEVIN BREWSTER, SHENZHEN (CN); XIAOYUAN MA, SHENZHEN (CN)

(21) Appl. No.: 16/029,728

(22) Filed: Jul. 9, 2018

(30) Foreign Application Priority Data
Jul. 2, 2018 (CN) 201810707361.8
Jul. 2, 2018 (CN) 201821030932.0

(51) Int. Cl. B25D 3/00

(52) U.S. Cl. CPC B25D 3/00

(57) ABSTRACT

The present invention is applicable to the technical field of decoration tools and provides a chisel. The chisel comprises a housing; a first guide device arranged in the housing; and a cam mechanism disposed in the housing, wherein the cam mechanism comprises a first end cam and a second end cam which are fixedly connected together and have cam end faces opposite to each other, a connecting device connected with a power device is arranged on one side, opposite to the cam end face, of the first end cam, and the second end cam is a hollow cam; a hollow portion capable of passing through the second end cam, wherein the hollow portion is in contact with and matches the cam end faces of the two end cams, to drive a driven member for movement of a chisel body.

### CROSS-REFERENCE TO RELATED APPLICATIONS

This application claims priority to Chinese Patent Application No. 201821030932.0 with a filing date of Jul. 2, 2018 and Chinese Patent Application No. 201810707361.8 with a filing date of Jul. 2, 2018. The content of the aforementioned applications, including any intervening amendments thereto, are incorporated herein by reference.

### TECHNICAL FIELD

The invention belongs to the technical field of decoration tools, and in particular relates to a chisel.

### BACKGROUND

In the architectural ornament construction, when ceramic tiles on the wall and the floor and the like are removed, it is still operated manually. Workers need to adopt methods such as a method of using a hammer to knock a chisel to remove the ceramic tiles, floors, etc. little by little, resulting in high labor intensity and low work efficiency of workers, thereby increasing construction costs.

### SUMMARY

The present invention provides a chisel, which aims to solve the problems of high labor intensity and low work efficiency of workers.

The present invention is implemented in this way: a chisel comprises:

a housing;

a first guide device arranged in the housing; and

a cam mechanism disposed in the housing, wherein the cam mechanism comprises a first end cam and a second end cam which are fixedly connected together and have cam end faces opposite to each other, a connecting device connected with a power device is arranged on one side, opposite to the cam end face, of the first end cam, and the second end cam is a hollow cam;

a hollow portion capable of passing through the second end cam, wherein the hollow portion is in contact with and matches the cam end faces of the two end cams, to drive a driven member for movement of the chisel, and the driven member is provided with a second guide device which can match the first guide device to make the driven member perform rectilinear motion.

Preferably, the cam mechanism further comprises an isolation block arranged between the two end cams, wherein the three are detachably connected together.

Further, the two end cams are respectively provided with at least two through holes, the isolation block is provided with a threaded hole corresponding to the through hole, and the three are fastened together by bolts.

Preferably, the first guide device is a guide groove; and the second guide device is a limiting post adaptive to the guide groove.

Preferably, the chisel further comprises at least two bearings for supporting the cam mechanism; and

bearing blocks arranged in the housing and corresponding to the bearings.

Preferably, the chisel and the driven member are of an integrally formed structure.

Preferably, the connecting device is a connecting rod.

Further, the connecting rod is provided with flat positions.

In the chisel provided by the present invention, the cam mechanism can be driven by the power device to move, to make a chisel body perform linear reciprocating motion, so that operations of removing ceramic tiles, floors, etc. can be completed. Since the chisel provided by the present invention can be driven by the power device and does not require workers to perform actions such as knocking, not only is the labor intensity of workers reduced, but also the work efficiency is improved, thereby reducing the construction cost.

### BRIEF DESCRIPTION OF DRAWINGS

FIG. 1 is an overall schematic view of a chisel provided by the present invention;

FIG. 2 is a schematic view of an internal structure of a housing provided by the present invention;

FIG. 3 is an overall schematic view of components in a housing provided by the present invention;

FIG. 4 is a front view of components in a housing provided by the present invention;

FIG. 5 is a schematic view of two positioned end cams provided by the present invention; and

FIG. 6 is a structural schematic view of a second end cam provided by the present invention.

### DESCRIPTION OF EMBODIMENTS

In order to make the objectives, technical solutions and advantages of the present invention clearer and more comprehensible, the following further describes the present invention in detail with reference to the accompanying drawings and embodiments. It should be understood that the specific embodiments described herein are only used to explain the present invention and are not used to limit the present invention.

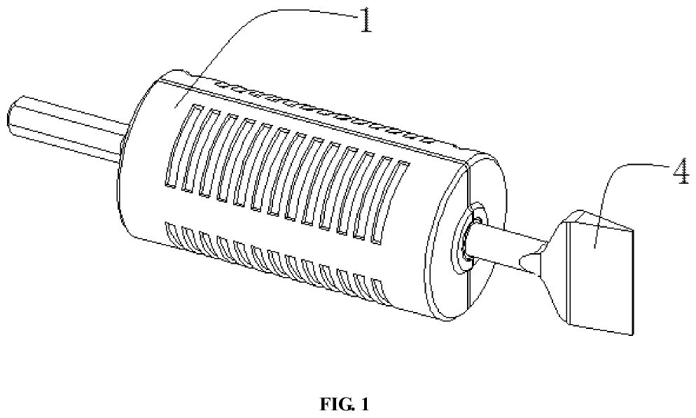

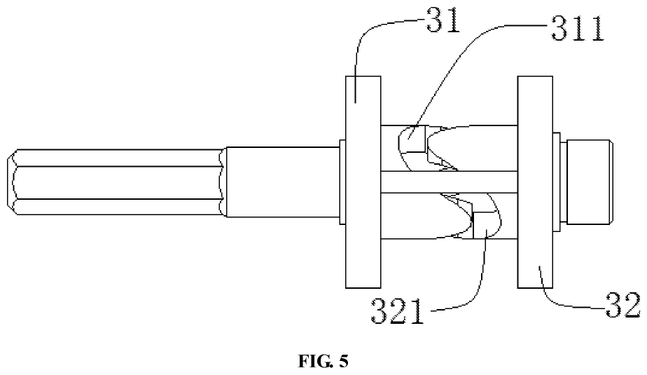

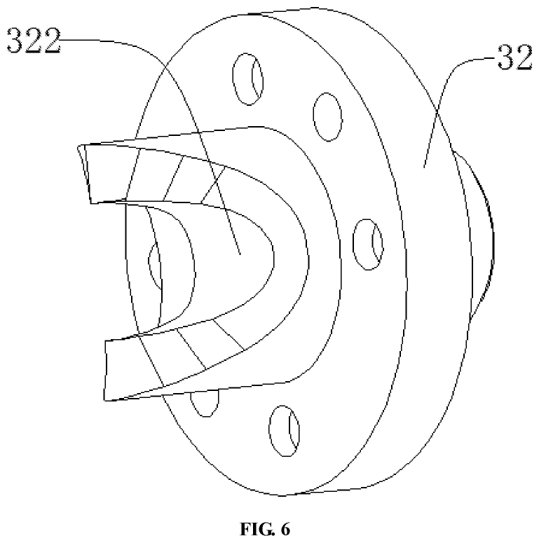

As shown in FIGS. 1 to 6, in the embodiment provided by the present invention, the chisel comprises:

a housing 1, wherein the housing 1 is composed of an upper housing and a lower housing which can match each other and it can be understood that for the sealing, a sealing gasket shall be arranged between the upper housing and the lower housing; a first guide device 2 disposed in the housing 1; and a cam mechanism 3 arranged in the housing 1, wherein the cam mechanism 3 comprises a first end cam 31 and a second end cam 32 which are fixedly connected together and have cam end faces (namely a cam end face 311 and a cam end face 321) opposite to each other, a connecting device 33 connected with a power device is arranged on one side, opposite to the cam end face, of the first end cam 31, and the second end cam 32 is a hollow cam; a hollow portion 322 capable of passing through the second end cam 32, wherein the hollow portion 322 is in contact with and matches the cam end faces of the two end cams, to drive a driven member 34 for movement of a chisel body 4 (such as a scraper knife), and the driven member 34 is provided with a second guide device 341 which can match the first guide device 2 to make the driven member 34 perform rectilinear motion.

In this embodiment, the two end cams are driven to rotate through the power device, and under the cooperation of the first guide device 2 and the second guide device 341, the driven member 34 linearly reciprocates, thereby driving the chisel body 4 to perform a linear reciprocating motion; operations of removing ceramic tiles, floors, etc. can be completed without requiring workers to knock the chisel, the labor intensity of workers is reduced, and the work efficiency is improved.

It can be understood that in this embodiment, the cam end faces of the two end cams should be adapted, that is, after being assembled, the cam mechanism shall ensure that the intervals between the two cam end faces are equal. In addition, in order to facilitate the addition of lubricating oil to the housing, the housing is provided with an oil hole, and a sealing cover capable of sealing the oil hole, such as a rubber stopper, is provided.

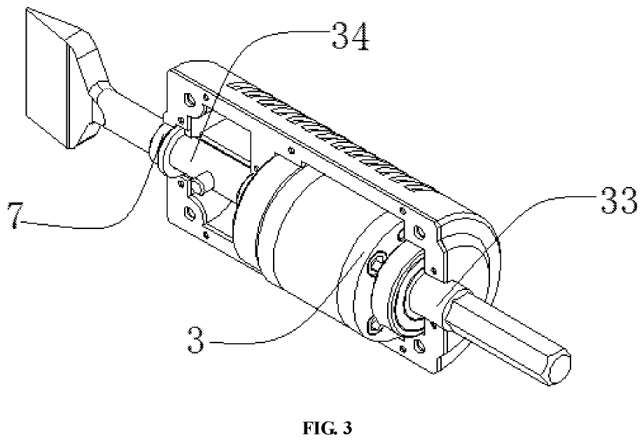

As shown in FIG. 3, the cam mechanism 3 further comprises an isolation block 35 disposed between the two end cams, and the three are detachably connected together. In this embodiment, the isolation block 35 is a hollow cylindrical block. The size of the hollow part should ensure that the cylindrical block does not interfere with the movement of the driven member 4.

The connection of the three may be as follows: the two end cams are respectively provided with at least two through holes, the isolation block 35 is provided with a threaded hole corresponding to the through hole, and the three are fastened together by bolts. In order to make the connection effect better, the number of these through holes is multiple and the through holes are evenly formed in the end cams where the through holes are located. The connection of the three may also be as follows: the two end cams and the isolation block 35 are provided with corresponding through holes, and the three are fastened together by bolts and corresponding nuts. In order to make the connection effect better, these through holes are evenly distributed in components where these through holes are located.

It can be understood that the function of the isolation block 35 is to make the assembly of the cam mechanism simpler. During assembly, the isolation block 35 is closely attached to the end faces of the two cams, and the length of the isolation block 35 is such that the clearance between the cam end faces of the end cams can match the driven member 34. That is, when the cams rotate, the cam end faces can exert force on the driven member, and make the driven member perform linear reciprocating motion under the action of the first guide device 2 and the second guide device 341.

In another embodiment provided by the present invention, the positioning and mounting of the two end cams can also be achieved only by the cooperation of bolts and nuts, which will not be described in detail herein in the present invention.

In this embodiment, the driven member 34 is a push rod, and a cylinder 342 protruding on the side of the push rod is disposed at the cooperation position of the two end cams. The cylinder 342 may be a cylindrical pin that is driven into the push rod (the push rod is provided with a corresponding hole), and may also be integrally formed with the push rod.

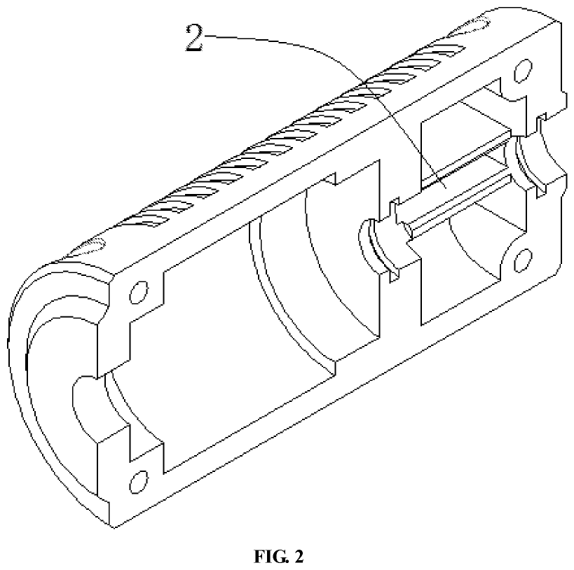

As shown in FIG. 2 and FIG. 3, in order to facilitate production and manufacturing, in an embodiment provided by the present invention, the first guide device 2 is a guide groove, the guide groove may be integrally formed with the housing by casting, and the second guide device 341 is a limiting post adaptive to the guide groove; the limiting post may be formed integrally with the driven part (i.e., the push rod) by casting, or may be formed by first drilling a hole in the driven member and then inserting a pin in the drilled hole. In order to make the guiding effect better, in an embodiment provided by the present invention, a guide sleeve 7 adapted to the push rod is also provided.

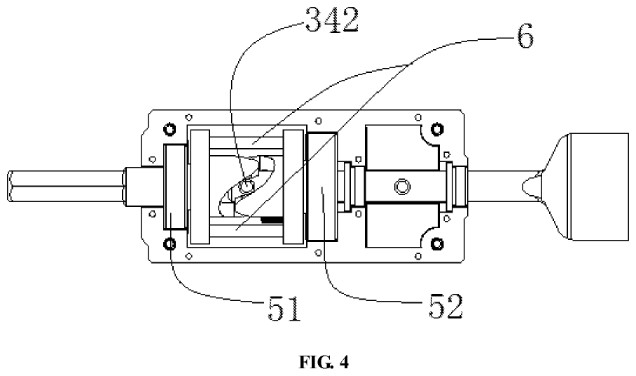

In this embodiment, the chisel further comprises at least two bearings that support the cam mechanism. Preferably, two bearings are used, namely, the bearing 51 and the bearing 52 in FIG. 4, and the bearings may be mounted on two end cams respectively. At this time, the two end cams are provided with bearing mounting positions. Specifically, in this embodiment, cam mounting positions are located at one end away from each cam end face; of course, opposite to this, the housing 1 should be internally provided with a bearing block corresponding to the bearing.

In this embodiment, for convenience in manufacturing and installation, the chisel body 4 and the driven member 34 (i.e., the push rod) are of an integrally formed structure. Of course, in order to facilitate the replacement of the chisel body, the two may be connected in a detachable manner such as through a pin connection, which will not be described in much detail herein in the present invention.

In an embodiment provided by the present invention, the power device may be a rotatable device such as an electric portable drill, and the connecting device is a connecting rod. In order to prevent slippage, a connecting rod for clamping the electric portable drill more firmly is provided with flat positions; preferably, the connecting rod is provided with a plurality of evenly arranged flat positions, and the number of the flat positions may be six.

In addition, as shown in FIG. 4, in order to facilitate the assembly, corresponding positioning holes are respectively formed in the two end cams. In this embodiment, two groups of positioning holes are used, and during assembly, positioning pins 6 adaptive to the through holes can be used for positioning first.

We claim:

1. A chisel, comprising:
a housing;
a first guide device arranged in the housing; and
a cam mechanism disposed in the housing, wherein the cam mechanism comprises a first end cam and a second end cam which are fixedly connected together and have cam end faces opposite to each other, a connecting device connected with a power device is arranged on one side, opposite to the cam end face, of the first end cam, and the second end cam is a hollow cam;
a hollow portion capable of passing through the second end cam, wherein the hollow portion is in contact with and matches the cam end faces of the two end cams, to drive a driven member for movement of a chisel body, and the driven member is provided with a second guide device which can match the first guide device to make the driven member perform rectilinear motion.

2. The chisel according to claim 1, wherein the cam mechanism further comprises an isolation block arranged between the two end cams, and the three are detachably connected together.

3. The chisel according to claim 2, wherein the two end cams are respectively provided with at least two through holes, the isolation block is provided with a threaded hole corresponding to the through hole, and the three are fastened together by bolts.

4. The chisel according to claim 1, wherein the first guide device is a guide groove; and the second guide device is a limiting post adaptive to the guide groove.

5. The chisel according to claim 1, wherein the chisel further comprises at least two bearings for supporting the cam mechanism; and
bearing blocks arranged in the housing and corresponding to the bearings.

6. The chisel according to claim 1, wherein the chisel body and the driven member are of an integrally formed structure.

7. The chisel according to claim 1, wherein the connecting device is a connecting rod.

8. The chisel according to claim 7, wherein the connecting rod is provided with flat positions.
